(19) United States
(12) Patent Application Publication
(10) Pub. No.: US 2014/0291228 A1
(43) Pub. Date: Oct. 2, 2014

(54) MACHINE TOOL WITH CUTTING FLUID FILTERING APPARATUS

(71) Applicant: FANUC Corporation, Yamanashi (JP)

(72) Inventor: Mitsuyoshi ISHIHARA, Yamanashi (JP)

(73) Assignee: Fanuc Corporation, Yamanashi (JP)

(21) Appl. No.: 14/227,944

(22) Filed: Mar. 27, 2014

(30) Foreign Application Priority Data
Mar. 28, 2013 (JP) 2013-069123

(51) Int. Cl. B01D 29/66; B01D 35/02

(52) U.S. Cl. CPC B01D 29/661; B01D 35/02
USPC 210/257.1

(57) ABSTRACT

A machine tool includes a negative pressure generator that removes chips and sludge having adhered to a suction filter that is provided at a suction port of a pump that pumps up a cutting fluid stored in a contaminated water tank that stores the cutting fluid or a partition filter that partitions the contaminated water tank into a first contaminated water tank and a second contaminated water tank. The negative pressure generator allows removal of impurities, such as chips and sludge, having adhered to the suction filter or the partition filter for cleaning without blowing the chips and sludge that have adhered to the filters against the suction filter or the partition filter.

### BACKGROUND OF THE INVENTION

1. Field of the Invention

The present invention relates to a machine tool using a system that cleans a filter and a mesh that are used to remove impurities, such as chips and sludge.

2. Description of the Related Art

In a machine tool, since impurities, such as chips and sludge, produced in a machining process contaminate a cutting fluid and adversely affect the performance and reliability of the tool, a filter for removing the impurities is used. Further, in fields other than machine tools as well, a filter and a mesh are typically used to remove impurities.

The filter and the mesh are cleaned to maintain the cleaning performance thereof and prolong the life thereof. A method of cleaning the filter and the mesh includes in some cases causing the cutting fluid to flow in the direction opposite to the direction in which the cutting fluid and any other fluid are caused to flow when used in normal machining operation to remove impurities, such as chips and sludge, having adhered to the filter and the mesh therefrom. The cleaning method is called backwashing operation.

The backwashing operation will be summarized below. First, inflow and outflow tubes of a filter container that accommodates a filter to be cleaned in the backwashing operation are closed so that a cutting fluid left in the filter and the filter container is immobilized. Subsequently, compressed air is supplied into the filter in the direction opposite to the direction in which the cutting fluid flows in normal machining operation and a discharge valve on a discharge tube connected to the filter container is opened, so that the cutting fluid pressurized by the compressed air passes through the filter and then flows through the opened discharge tube. In this process, the flow of the cutting fluid removes impurities, such as chips and sludge, having adhered to the filter.

FIG. 4 describes a cutting fluid filtering apparatus provided in a conventional machine tool.

In FIG. 4, reference character 110 denotes a tank. Reference character 111 denotes a filter pump. Reference character 112 denotes an inflow valve. Reference character 113 denotes a filter container that accommodates a filter. Reference character 114 denotes a differential pressure switch. Reference character 115 denotes a discharge valve. Reference character 116 denotes an air source. Reference character 117 denotes an air supply valve. Reference character 118 denotes an outflow valve. Reference character 119 denotes a chip-containing cutting fluid. Reference characters 120, 121, 122, and 123 denote tubes. Reference character 170 denotes a machine tool body.

A controller (not shown) provided in the machine tool body 170 activates the cutting fluid filtering apparatus to drive the filter pump 111, which pumps up the chip-containing cutting fluid 119 through the tube 120 and supplies the cutting fluid through the filter container 113, where the cutting fluid is filtered through the filter, to the machine tool body 170. The filter container 113 accommodates a filter (not shown) for filtering out chips from the chip-containing cutting fluid.

In the course of the filtration of the chip-containing cutting fluid 119 stored in the tank 110, the amount of chips that adhere to the filter in the filter container 113 gradually increases. As a result, the difference in pressure between the tubes 121 and 122 increases. When the difference in pressure between the tubes 121 and 122 is equal to or greater than a preset value, the differential pressure switch 114 is activated to initiate the backwashing operation.

In the backwashing operation, the drive of the filter pump 111 is first stopped to suspend the operation of pumping up the chip-containing cutting fluid 119 stored in the tank 110, and the inflow tube 121 and the outflow tube 122 connected to the filter container 113 are closed by using the valves (inflow valve 112 and outflow valve 118). As a result, the cutting fluid left in the filter container 113 cannot flow out toward the tank 110 or the machine tool body 170.

Subsequently, the valve connected to the air source 116 (air supply value 117) is opened to supply compressed air into the filter container 113 in the direction opposite to the direction in which the cutting fluid flows in normal machining operation. Thereafter, the air supply valve 117 connected to the air source 116 is closed and the discharge valve 115 connected to the filter container 113 is opened, so that the cutting fluid pressurized by the compressed air passes through the filter in the filter container 113 in the direction opposite to the direction in which the cutting fluid flows in normal machining operation, then passes through the discharge valve 115 provided on the tube 123, and returns into the tank 110. The flow of the cutting fluid removes chips and sludge that have adhered to the filter.

In a machine tool, the method described above allows removal of chips and sludge that have adhered to the filter through which a cutting fluid passes in machining operation. Chips and sludge may, however, also adhere to a suction filter attached to the front end of the filter pump 111, a partition filter that partitions the tank, and other filters in some cases.

As a method of removing chips and sludge that have adhered to the suction filter attached to the pump, Japanese Patent Application Laid-Open No. 2004-74358 discloses a technology for using the flow of the air used to remove impurities, such as chips and sludge, having adhered to the impurity removing filter in the backwashing operation, specifically, blowing the air against the suction filter attached to the pump to remove chips and sludge that have adhered to the suction filter.

Further, Japanese Patent Application Laid-Open No. 2012-218127 discloses a technology used in a lathe, which is a machine tool, to suck chips produced by a cutter in a cutting process through a chip suction port through which the chips are sucked.

The backwashing operation based on the conventional technology can remove chips and sludge having adhered to the filter through which the cutting fluid passes in a cutting process but cannot remove impurities, such as chips and sludge, having adhered to the suction filter attached to the front end of the filter pump 111, the partition filter that partitions the tank, and other filters.

The technology disclosed in Japanese Patent Application Laid-Open No. 2004-74358 described above, in which the air used to remove impurities, such as chips and sludge, having adhered to the impurity removing filter in the backwashing operation is blown against the suction filter attached to the pump to remove chips and sludge that have adhered to the suction filter, is likely to cause chips and sludge to newly adhere to the surface of the suction filter when the cutting fluid is blown against the suction filter because the cutting fluid blown against the suction filter in the backwashing operation contains chips and sludge that have been removed from the impurity removing filter.

Further, Japanese Patent Application Laid-Open No. 2012-218127 described above, which discloses the technology for sucking chips produced by a cutter, does not remove chips and sludge that have adhered to the suction filter by using the backwashing operation.

### SUMMARY OF THE INVENTION

In view of the facts described above, the present invention aims to provide a machine tool using a system that cleans a filter and a mesh that are used to remove impurities, such as chips and sludge, in the machine tool.

The present invention relates to a machine tool with a cutting fluid filtering apparatus. According to a first aspect of the present invention, the machine tool includes a contaminated water tank that stores a cutting fluid used in workpiece machining operation performed on the machine tool and a pump that pumps up the cutting fluid stored in the contaminated water tank, and the cutting fluid filtering apparatus has a backwashing function of not only causing the cutting fluid pumped up by the pump to flow through an inflow port of a filter container that accommodates a filter and causing the cutting fluid to flow out of an opening of the filter container to filter impurities through the filter but also supplying compressed air or the cutting fluid through the opening to remove the filtered impurities from the filter and discharge the impurities through a discharge port of the filter container. The machine tool further includes a suction filter that is provided at a suction port of the pump and filters the cutting fluid in the contaminated water tank and a negative pressure generator that is provided in the vicinity of the suction filter and generates a negative pressure.

In the first aspect of the machine tool with a cutting fluid filtering apparatus described above, providing the negative pressure generator that generates a negative pressure in the vicinity of the suction filter, it is possible to remove impurities, such as chips and sludge, having adhered to the suction filter. Further, unlike the related art, since the cutting fluid containing chips and sludge removed from the filter is not blown against the suction filter, the chips and sludge removed from the filter will not adhere to the suction filter.

According to a second aspect of the machine tool with a cutting fluid filtering apparatus of the present invention, the machine tool includes a first contaminated water tank that stores a cutting fluid used in workpiece machining operation performed on the machine tool, a second contaminated water tank connected to the first contaminated water tank via a partition filter, and a pump that pumps up the cutting fluid stored in the second contaminated water tank. The cutting fluid filtering apparatus has a backwashing function of not only causing the cutting fluid pumped up by the pump to flow through an inflow port of a filter container that accommodates a filter and causing the cutting fluid to flow out of an opening of the filter container to filter impurities through the filter but also supplying compressed air or the cutting fluid through the opening to remove the filtered impurities from the filter and discharge the impurities through a discharge port of the filter container. The machine tool further includes a negative pressure generator that is provided in the first contaminated water tank in the vicinity of the partition filter and generates a negative pressure.

In the second aspect of the machine tool with a cutting fluid filtering apparatus described above, providing the negative pressure generator that generates a negative pressure in the vicinity of the partition filter in the contaminated water, it is possible to remove impurities, such as chips and sludge, having adhered to the partition filter. Further, unlike the related art, since the cutting fluid containing chips and sludge removed from the filter is not blown against the partition filter, the chips and sludge removed from the filter will not adhere to the partition filter.

The negative pressure generator may generate a negative pressure by causing the compressed air or the cutting fluid discharged through the discharge port described above to pass through the negative pressure generator. In this embodiment, no compressor that supplies compressed air or no pump that supplies a cutting fluid for causing the negative pressure generator to generate a negative pressure is separately provided, but the flow of the compressed air or the cutting fluid discharged from the filter container to the contaminated water tank in the backwashing operation is used. Specifically, the flow is supplied to the negative pressure generator to cause it to generate a negative pressure. A sucking force based on the negative pressure can remove impurities, such as chips and sludge, having adhered to the partition filter.

The present invention can provide a machine tool using a system that cleans a filter and a mesh that are used to remove impurities, such as chips and sludge, in the machine tool to enhance a backwashing effect of the filter.

### BRIEF DESCRIPTION OF THE DRAWINGS

The above and other objects and the above and other features of the present invention will be apparent from the following description of embodiments when taken with reference to the accompanying drawings.

FIG. 1 describes a first example of a cutting fluid filtering apparatus provided in a machine tool according to the present invention;

FIG. 2 describes a second example of the cutting fluid filtering apparatus provided in a machine tool according to the present invention;

FIG. 3 is a schematic view schematically showing a negative pressure generator provided in the cutting fluid filtering apparatus shown in FIGS. 1 and 2; and

FIG. 4 describes a cutting fluid filtering apparatus provided in a conventional machine.

### DETAILED DESCRIPTION OF THE PREFERRED EMBODIMENTS

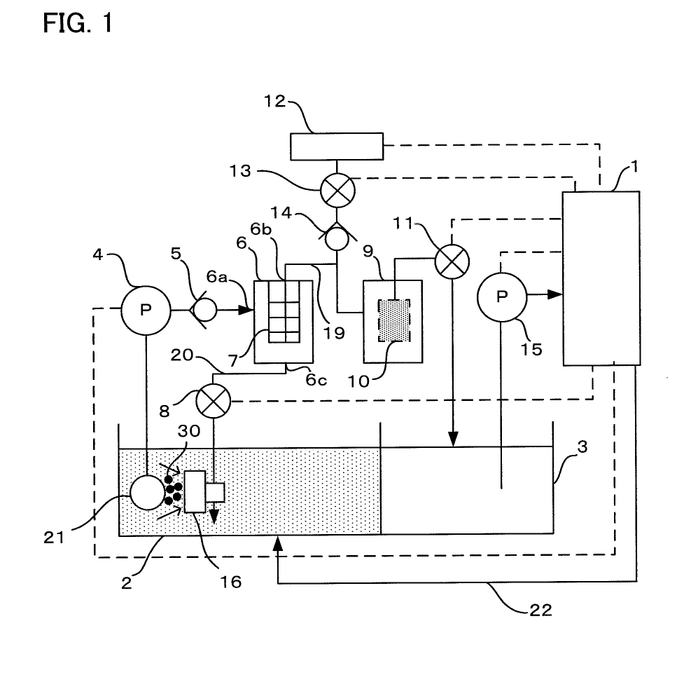

A first example of a cutting fluid filtering apparatus provided in a machine tool according to the present invention will first be described with reference to FIG. 1.

In FIG. 1, reference character 1 denotes a machine tool body including a controller. Reference character 2 denotes a contaminated water tank. Reference character 3 denotes a clean water tank. Reference character 4 denotes a filter pump. Reference character 5 denotes a check valve provided in a position downstream of the filter pump 4 when viewed along the flow of a cutting fluid. Reference character 6 denotes a backwashing filter container including an inflow port 6a, into which the cutting fluid from the filter pump 4 flows, an opening 6b, out of which the cutting fluid flows in a filtering process and into which air flows in a backwashing process, and a discharge port 6c, out of which the air and the cutting fluid are discharged in the backwashing process, and a backwashing filter 7 is provided in the backwashing filter container 6. Reference character 8 denotes a backwashing discharge valve. Reference character 11 denotes a clean water tank valve. Reference character 12 denotes an air source. Reference character 13 denotes an air supply valve. Reference character 14 denotes a check valve provided in a position downstream of the air supply valve 13 when viewed along the flow of the air. Reference character 15 denotes a cutting fluid supply pump.

The machine tool body 1 machines a workpiece (not shown) under the control of the controller. The cutting fluid supply pump 15, which is controlled by the controller that controls the machine tool body 1, supplies the machine tool body 1 with a filtered cutting fluid stored in the clean water tank 3. After used in the workpiece machining process, the cutting fluid is recovered through a tube 22 to the contaminated water tank 2.

The controller is incorporated in the machine tool body 1 and not only controls the machine tool body 1 but also controls drive operation of the filter pump 4 and the air source 12 and open/close operation of the backwashing discharge valve 8, the clean water tank valve 11, and the air supply valve 13, as indicated by the dotted lines in FIG. 1.

A description will first be made of filtration of the cutting fluid containing impurities produced in the machining process carried out by the machine tool.

The contaminated water tank 2 stores the cutting fluid recovered from the machine tool body 1, and the recovered cutting fluid contains impurities, such as chips and sludge. The filter pump 4 pumps up the impurity-containing cutting fluid stored in the contaminated water tank 2 and supplies the backwashing filter container 6 with the recovered cutting fluid through the inflow port 6a. The backwashing filter container 6 accommodates the backwashing filter 7, which removes impurities, such as chips and sludge, by which the cutting fluid is contaminated. The check valve 5 is provided in a position between the filter pump 4 and the backwashing filter container 6 and prevents the cutting fluid from the backwashing filter container 6 and compressed air, which will be described later, from flowing back toward the filter pump 4. Further, the backwashing discharge valve 8 is provided in a position between the discharge port 6c of the backwashing filter container 6 and the contaminated water tank 2, and the clean water tank valve 11 is provided in a position between an outflow port and the clean water tank 3.

To filter the impurity-containing cutting fluid, the valves are controlled as follows: the clean water tank valve 11 is open; the backwashing discharge valve 8 is closed; and the air supply valve 13 is closed, and the cutting fluid is pumped up by the filter pump 4 from the contaminated water tank 2 and supplied through the check valve 5 and the inflow port 6a to the backwashing filter container 6 (backwashing filter 7), where impurities, such as chips and sludge, are removed. The filtered cutting fluid is then supplied through the opening 6b to a line filter container 9, which accommodates a line filter 10. The line filter 10 is a finer-meshed filter than the backwashing filter 7. Before the cutting fluid is supplied, the cutting fluid filtered through the backwashing filter 7 is further filtered through the finer-meshed line filter 10, whereby the performance of filtration of the cutting fluid supplied to the clean water tank 3 can be improved. The cutting fluid discharged from the line filter 10 is further discharged through the clean water tank valve 11 into the clean water tank 3. The flow of the cutting fluid in the backwashing filter in the backwashing filter container 6 is well known and will therefore not be described here.

A fluid surface height detection sensor (not shown) is provided in the clean water tank 3. When the fluid surface lowers, the filter pump 4 is activated and supplies the clean water tank 3 with the cutting fluid that has undergone the filtration through the backwashing filter 7.

The backwashing filter 7 in the backwashing filter container 6, which removes impurities, such as chips and sludge, undergoes cleaning operation in some cases in which chips and sludge that have adhered to the backwashing filter 7 are removed in order to maintain the performance of the backwashing filter 7 and prolong the life thereof. An example of the cleaning operation of the backwashing filter 7 is backwashing operation. How to perform the backwashing operation will be described with reference to FIG. 1.

First, the inflow-side check valve 5 and the outflow-side clean water tank valve 11 attached to the backwashing filter container 6, which accommodates the backwashing filter 7 to be cleaned, are closed so that the cutting fluid left in the backwashing filter container 6 is immobilized. Subsequently, the air supply valve 13 connected to the air source 12 and the check valve 14 are opened, and the backwashing filter container 6 is supplied with compressed air through the opening 6b in the direction opposite to the direction in which the cutting fluid flows in normal machining operation. The backwashing discharge valve 8 is then opened to allow the cutting fluid pressurized by the compressed air to pass through the backwashing filter container 6 in the direction opposite to the direction in which the cutting fluid flows in normal machining operation. The cutting fluid then exits out of the discharge port 6c, passes through the backwashing discharge valve 8, and returns to the contaminated water tank 2. The flow of the cutting fluid can remove impurities, such as chips and sludge, having adhered to the backwashing filter 7.

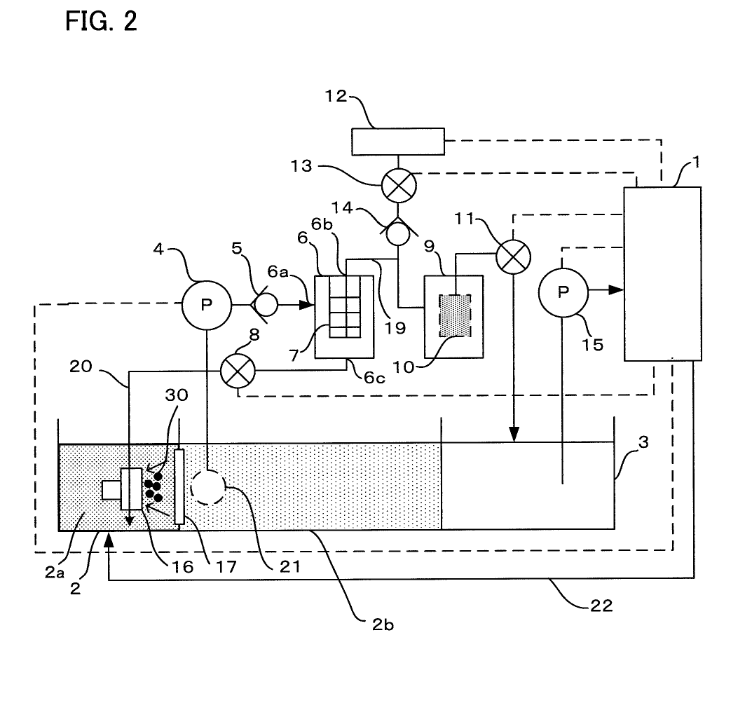

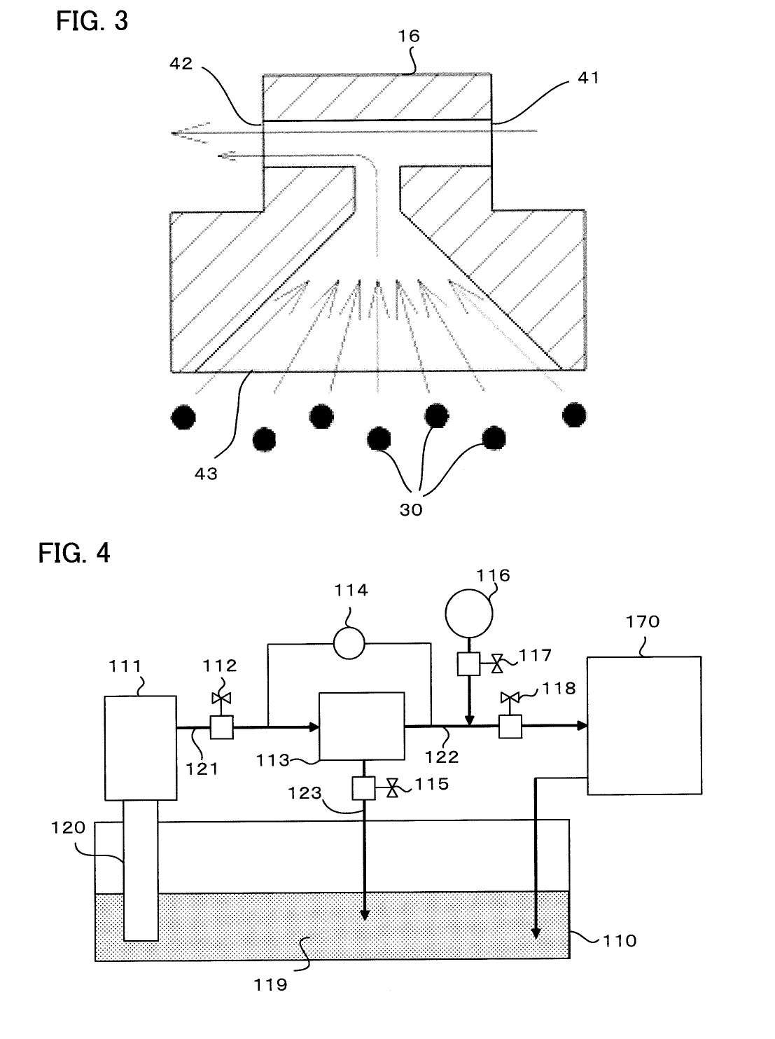

A description will next be made, with reference to FIG. 3, of generation of a negative pressure in a negative pressure generator provided in the cutting fluid filtering apparatus shown in FIGS. 1 and 2.

In FIG. 3, reference character 41 denotes an inflow port. Reference character 42 denotes a discharge port. Reference character 43 denotes a suction port. In the backwashing operation, the cutting fluid or the compressed air discharged from the backwashing filter 7 flows in through the inflow port 41 of a negative pressure generator 16 and flows out of the discharge port 42 thereof. The flow of the cutting fluid or the compressed air reduces the pressure in the negative pressure generator 16, in which a negative pressure is therefore generated, whereby a flow of the cutting fluid from the suction port 43 to the discharge port 42 is produced. As a result, chips 30 and other impurities present in the vicinity of the suction port 43 are sucked and discharged through the discharge port 42.

In the cutting fluid filtering apparatus shown in FIG. 1, in which the suction port 43 of the negative pressure generator 16 is so disposed that it faces a suction filter 21 as shown in FIG. 1, a suction force based on the negative pressure generated by the negative pressure generator 16 in the backwashing operation removes the chips 30 and other impurities that have adhered to the suction filter 21.

A second example of the cutting fluid filtering apparatus provided in a machine tool according to the present invention will next be described with reference to FIG. 2. In this example, a partition filter 17 partitions the contaminated water tank 2 into a first contaminated water tank 2a and a second contaminated water tank 2b.

The filtered cutting fluid stored in the clean water tank 3 is supplied to the machine tool body 1, and the supplied cutting fluid is used in a workpiece machining process and then recovered through the tube 22 into the first contaminated water tank 2a. The cutting fluid is then supplied from the first contaminated water tank 2a through the partition filter 17 into the second contaminated water tank 2b. The cutting fluid pumped up from the second contaminated water tank 2b by the filter pump 4 is supplied through the inflow port 6a into the backwashing filter container 6.

On the other hand, in the backwashing operation, the cutting fluid and the compressed air from the backwashing filter container 6 are discharged into the first contaminated water tank 2a.

In the cutting fluid filtering apparatus shown in FIG. 2, the chips 30 and other impurities adhere to the partition filter 17 when the cutting fluid is supplied form the first contaminated water tank 2a to the second contaminated water tank 2b. In this situation, the suction port 43 of the negative pressure generator 16 is so disposed that it faces the partition filter 17, whereby a suction force based on the negative pressure generated by the negative pressure generator 16 in the backwashing operation removes the chips 30 and other impurities that have adhered to the partition filter 17.

In the cutting fluid filtering apparatus shown in FIG. 2, in which the suction filter 21 is provided at a location where the suction filter 21 comes into contact with the cutting fluid flowing toward the filter pump 4, the suction filter 21 is not necessarily provided in a case where the partition filter 17 can sufficiently remove the chips 30 and other impurities.

Further, in the cutting fluid filtering apparatus shown in FIG. 2, the single negative pressure generator 16 is disposed at the single partition filter 17. When the single partition filter 17 is replaced with a plurality of partition filters 17, the single negative pressure generator 16 may be configured to clean the plurality of partition filters 17. Further, when the partition filter 17 and the suction filter 21 for the filter pump 4 are provided, the single negative pressure generator 16 may be configured to clean the partition filter 17 and the suction filter 21. Conversely, separate negative pressure generators 16 may be used to clean the partition filter 17 and the suction filter 21, respectively.

In the negative pressure generator 16 provided in the cutting fluid filtering apparatus shown in FIGS. 1 and 2, a negative pressure is generated by using the flow of the compressed air and the cutting fluid in the backwashing operation, but the negative pressure generator 16 is not necessarily activated by the compressed air and the cutting fluid in the backwashing operation. Instead, the negative pressure generator 16 may be activated, for example, by using any other power source.

Further, in the cutting fluid filtration shown in FIGS. 1 and 2, the cutting fluid filtered through the line filter 10 is temporarily stored in the clean water tank 3 and then supplied to the machine tool body 1. Instead, no clean water tank 3 may be provided, and the cutting fluid filtered through the line filter 10 may be directly supplied to the machine tool body 1.

Further, in the cutting fluid filtering apparatus shown in FIGS. 1 and 2, the internal filters are formed of the two filters, that is, the backwashing filter 7 and the line filter 10, but only the backwashing filter 7 may be provided.

1. A machine tool with a cutting fluid filtering apparatus, the machine tool comprising:
a contaminated water tank that stores a cutting fluid used in workpiece machining operation performed on the machine tool; and
a pump that pumps up the cutting fluid stored in the contaminated water tank,
wherein the cutting fluid filtering apparatus has a backwashing function of not only causing the cutting fluid pumped up by the pump to flow through an inflow port of a filter container that accommodates a filter and causing the cutting fluid to flow out of an opening of the filter container to filter impurities through the filter but also supplying compressed air or the cutting fluid through the opening to remove the filtered impurities from the filter and discharge the impurities through a discharge port of the filter container, and
the machine tool further comprises:
a suction filter that is provided at a suction port of the pump and filters the cutting fluid in the contaminated water tank, and
a negative pressure generator that is provided in a vicinity of the suction filter and generates a negative pressure.

2. A machine tool with a cutting fluid filtering apparatus, the machine tool comprising:
a first contaminated water tank that stores a cutting fluid used in workpiece machining operation performed on the machine tool;
a second contaminated water tank connected to the first contaminated water tank via a partition filter; and
a pump that pumps up the cutting fluid stored in the second contaminated water tank,
wherein the cutting fluid filtering apparatus has a backwashing function of not only causing the cutting fluid pumped up by the pump to flow through an inflow port of a filter container that accommodates a filter and causing the cutting fluid to flow out of an opening of the filter container to filter impurities through the filter but also supplying compressed air or the cutting fluid through the opening to remove the filtered impurities from the filter and discharge the impurities through a discharge port of the filter container, and
the machine tool further comprise a negative pressure generator that is provided in the first contaminated water tank in the vicinity of the partition filter and generates a negative pressure.

3. The machine tool with a cutting fluid filtering apparatus according to claim 1,
wherein the negative pressure generator generates a negative pressure by causing the compressed air or the cutting fluid discharged through the discharge port to pass through the negative pressure generator.
